(19) United States
(12) Patent Application Publication
(10) Pub. No.: US 2008/0217342 A1
(43) Pub. Date: Sep. 11, 2008

(54) Cooler with an attachment element

(76) Inventor: Richard Cinque, Carlsbad, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/075,206

(22) Filed: Mar. 10, 2008

Related U.S. Application Data
(60) Provisional application No. 60/905,728, filed on Mar. 8, 2007.

(51) Int. Cl. B65D 81/38; F25D 3/08; B62B 5/00; B65G 65/00; B65D 6/16

(52) U.S. Cl. 220/592.2; 62/457.1; 220/6; 280/33.992; 414/800

(57) ABSTRACT

A cooler device with an attachment element is disclosed. The attachment element is configure to removable connect the cooler to another object, such as a shopping cart.

### CROSS REFERENCE TO RELATED APPLICATIONS

This application claims priority to U.S. Provisional No. 60/905,728, titled “Cooler with an Attachment Element,” filed Mar. 8, 2007, which is hereby incorporated by reference in its entirety.

### BACKGROUND

1. Field of the Invention

The field of the invention relates to a portable cooler configured to be attached to another object.

2. Description of the Related Technology

Portable coolers are configured to store and insulate contents so that the contents remain within a desired temperature range for a longer period of time than if not stored in the cooler. Conventional coolers generally have a storage area surrounded by an insulation material. Some conventional coolers have portions which can be either heated or cooled prior to use, so that the contents are better maintained at or near the desired temperature. Similarly, some conventional coolers have portions configured to hold elements which are either heated or cooled prior to use.

Portability of conventional coolers is supported generally by a handle and sometimes by wheels. The handle is configured to be grasped with a hand, whereby the user can carry or pull the cooler.

### SUMMARY OF CERTAIN INVENTIVE ASPECTS

The systems, methods, and devices of the invention each have several aspects, no single one of which is solely responsible for its desirable attributes. Without limiting the scope of this invention, its more prominent features will now be discussed briefly. After considering this discussion, and particularly after reading the section entitled “Detailed Description of Certain Embodiments” one will understand how the features of this invention provide advantages over other cooler devices.

One aspect is a cooler, including a cooler body having an inside and an outside, the body having a top and a bottom and one or more walls extending between the top and the bottom, where the walls are insulated, and an attachment element affixed to the outside of the cooler body, adapted to connect a wall of the cooler body to a separate structure. The attachment element may be affixed anywhere on the cooler body. In some embodiments the attachment element connects the cooler body to a separate structure. In some embodiments, the walls and the bottom of the cooler body are rigid, and the attachment element is rigid. In some embodiments, the attachment element includes at least a first hooked structure rigidly attached to a wall of the cooler body at an attachment point and extending outward from the attachment point and then downward, thereby allowing attachment of the cooler to a relatively thin horizontal or vertical structure by engaging the hook down over the horizontal or vertical structure. In some embodiments, the cooler includes a second hooked structure separated from the first hooked structure. The first and second hooks may be horizontally aligned. In some embodiments, the one or more walls of the cooler include foldable portions such that the cooler is substantially collapsible. In some embodiments, at least one portion of the cooler is flexible.

Another aspect is a system for carrying cooled foods. The system may include a shopping cart having wheels, a basket mounted above the wheels, a handle for operating the cart, a front end opposite the handle, and a rigid cooler removably attached to the front of the shopping cart. In some embodiments, the cooler is attached to the shopping cart by one or more hooks extending over a portion of the basket or another structure of the shopping cart. In some embodiments, the cooler is mounted to a structure of the shopping cart so it is positioned inside the basket, while in other embodiments the cooler is mounted on a structure of the shopping cart so it is positioned outside the basket.

Another aspect is a method for handling refrigerated or frozen food, including transporting a (rigid or non-rigid) cooler to a food store, attaching the cooler to a shopping cart, placing refrigerated or frozen food from the food store into the cooler, paying for the food, detaching the cooler from the cart, and transporting the cooler containing the refrigerated or frozen food away from the food store. In some embodiments the method includes removing the refrigerated or frozen food from the cooler to purchase the food, and replacing the refrigerated or frozen food back into the cooler after it is purchased. In some embodiments, the cooler is removably attached to a front of the shopping cart with at least one attachment element that extends downwardly over the front of the shopping cart. The cooler can be mounted inside or outside the shopping cart basket. In some embodiments, the method further includes placing non-refrigerated food in the shopping cart prior to removing the frozen food to purchase the food.

Another aspect is a food holding system, where the system includes a cooler having a rigid hooked attachment element, and the cooler also may have a rigid side wall. The attachment element can extend outwardly from the side wall and then downward. The cooler is configured to hold food inside the cooler that is colder than or warmer than ambient temperature and insulate the food from the ambient temperature outside of the cooler. The system also can include a horizontally or vertically-extending structure over which, or through which, the cooler is attached by means of the attachment element. In some embodiments, the structure is a fence. In some embodiments, the structure is a seat. In some embodiments, the structure is a portion of a shopping cart, for example, a front portion, a side portion, structure underneath the shopping cart basket, or structure underneath the handle.

### BRIEF DESCRIPTION OF THE DRAWINGS

FIGS. 1A and 1B are perspective views illustrating an embodiment of a cooler with an attachment element.

FIGS. 2A and 2B are perspective views illustrating another embodiment of a cooler with an attachment element.

FIGS. 3A-3H constitute a serial view showing how an embodiment may be used.

### DETAILED DESCRIPTION OF CERTAIN EMBODIMENTS

Embodiments of coolers are presented herein which provide the benefits of being configured to easily be removably attached to another object. Such convenience is particularly desirable when a user wishes to temporarily support the cooler with another object.

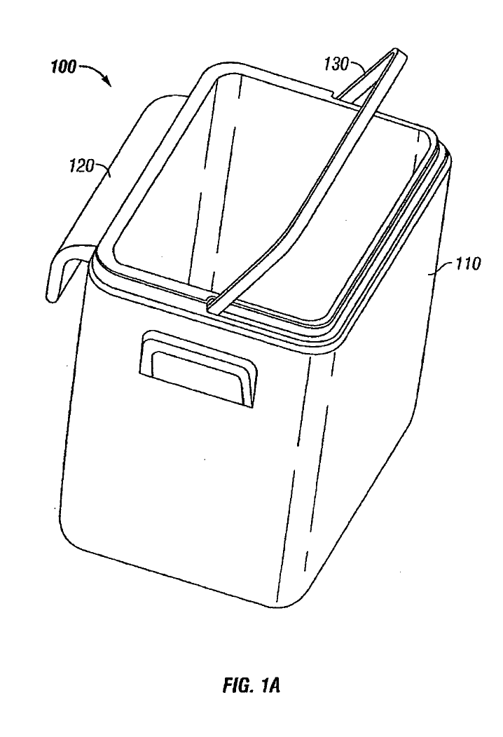

FIGS. 1A and 1B are perspective views illustrating an embodiment of a cooler 100 with an insulative portion 110, an attachment element 120, and a handle 130. Attachment element 120 is configured to allow the cooler 100 to be attached to another object. For example, the cooler 100 can be attached to a shopping cart, a boat, a car, or a fence. The object to which the cooler 100 can be attached may be configured with an object to which the cooler 100 is adapted to attach to. For example, an attachment bar may be connected to a golf cart, where the attachment bar is configured to receive and hold the cooler 100 with attachment element 120. The size and shape of the attachment element 120 can vary and can be configured for specific uses.

Insulative portion 110 can include the walls, top and/or bottom of the cooler 100, and is configured to hold one or more items and to thermally insulate the items from the environment outside of the cooler 100. Insulative portion 110 can have a variety of sizes, and shapes, and can be formed of various thermally insulative materials. In some embodiments, insulative portion 110 has multiple compartments which are thermally insulated from one another. In some embodiments, the insulative portion 110 has wheels. In some embodiments, the insulative portion 110 is rigid and in other embodiments the insulative portion 110 has one or more flexible components. For example, the insulative portion 110 may have a rigid top, flexible sides, and a flexible bottom, or the insulative portion 110 may have a flexible top, flexible sides, and a rigid bottom. The insulative portion 110 may include one or more advertising areas thereon. Other combinations may also be implemented. In some embodiments, the cooler 100 comprises portions which are configured to fold so that the cooler 100 is substantially collapsible. In some embodiments, to improve the temperature stability of the cooler 100, the insulative portion 110 comprises one or more components which are configured to be heated or cooled prior to storing an item. Similarly, in some embodiments, to improve the temperature maintenance of the cooler 100, the insulative portion 110 is configured to hold one or more articles which have been heated or cooled prior to use of the cooler.

In some embodiments, the attachment element 120 can be configured such that when the cooler is attached to a shopping cart, the shopping cart supports the cooler by the attachment element 120. For example, the insulative portion 110 is on one side of a supporting portion of the shopping cart and the attachment element 120 is in the form of at least one hook that extends outward from a wall of the cooler and over and around the top of the supporting portion to the other side of the supporting portion. The cooler can be attached to the front, side, or back (handle-side) of the shopping cart including below the basket or below the handle.

The described embodiments are beneficial for keeping a frozen item in an insulated environment that can be easily attached to and removed from a shopping cart, allowing for particularly beneficial use of the cooler 100 while purchasing cold or hot items. For example, a user can attach the cooler 100 to a selected shopping cart and gather items to be purchased from a store. After selecting an item which is preferably kept at a certain temperature, such as ice cream, poultry, meat, dairy frozen items, or hot cooked chicken, the item is placed into the cooler 100. The user can continue shopping for some time without concern about drastic temperature change of the item, and when ready to leave, present the cooler to pay for the items. If removed for purposes of purchase, the items can be quickly replaced into the cooler for subsequent transport in the insulated environment away from the food store. With such a device, the user can comfortably leave the items in the cooler 100 for a time, rather than needing to quickly transport the items so as to prevent undesired temperature change. In some embodiments, the food holding space of the cooler is divided into two or more spaces, each insulated and insulated from the other. In such an embodiment, hot food may be placed in a first space and cold or frozen items may be placed in a second space so that the temperature of the hot and cold food items do not affect the other.

Attachment element 120 may be configured to allow for the shopping cart to support the cooler 100 while in use such that the insulative portion 110 is optionally within the shopping cart basket or outside of the shopping cart basket. Such flexibility may be advantageous as a shopper may prefer to use the shopping cart space for other items, or may prefer that when used, or the user may prefer that the cooler not extend beyond the cart to which the cooler 100 is attached. In some embodiments, the attachment element 120 is configured with dimensions particularly advantageous for use with a shopping cart or other specific objects. For example, the spacing between the end of the attachment element 120 and the insulative portion 110 can be only slightly larger than the width of a wall of a shopping cart. In some embodiments, the attachment element 120 has a clip or other securing feature configured to securely attach onto a shopping cart or other object. In some embodiments, the attachment element 120 is integrated with the insulative portion 110 or a wall of the cooler 100. In some embodiments the attachment element 120 is separately formed and then connected to the insulative portion 110 or wall of the cooler.

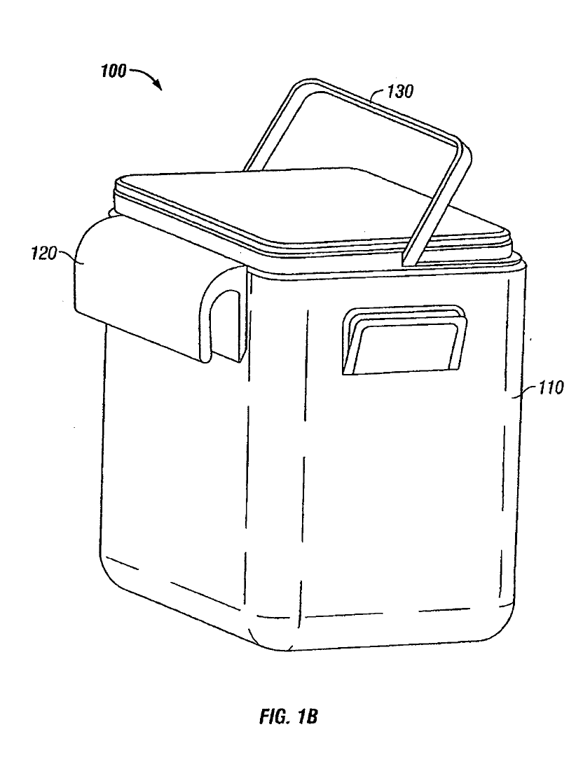

FIGS. 2A and 2B are perspective views illustrating another embodiment of a cooler 200 with an insulative portion 210, an attachment element 220, and a handle 230. Attachment element 220 is configured to allow the cooler 200 to be attached to another object.

Insulative portion 210 may have similar features as the insulative portion 110 described with reference to FIGS. 1A and 1B. The attachment element 220 of cooler 200 comprises two attachment sections 221 and 222. The attachment sections 221 and 222 can be aligned horizontally on the cooler to facilitate the cooler being held level and upright when attached to a structure. The two attachment sections 221 and 222 allow for the cooler 200 to be conveniently attached to a shopping cart or other objects, for example a fence with holes. In some embodiments, the attachment sections are configured to fix through the opening in a chain link fence. The attachment sections 221 and 222 have a size which allows them to be inserted into holes of a fence. After insertion, the fence supports the cooler 200 by the attachment sections 221 and 222. Such an arrangement is particularly beneficial at, for example, a park for people having a picnic, who would like the cooler 200 to be elevated off the ground. The arrangement is also particularly beneficial for use, for example, by softball players in a dugout. The cooler 200 can be hung, for example, from a fence separating the players from the field. The cooler 200 in this location is more convenient that if it were to be located on the ground because bending over for access is unnecessary. The fence location is also more convenient than on the bench because the bench space is free for other uses, and the risk of the cooler 200 being knocked from the bench is avoided.

Having two attachment sections 221 and 222 also allows for convenient attachment to a curved support, such as the back of a stadium seat. Such a cooler would be beneficial, for example, for a spectator while watching an event. The cooler can be placed on a seat in front of the spectator for easy access to the contents which are kept at a cool or a hot temperature.

In some embodiments, the cooler may have more than two attachment sections. For example, a third attachment section may be connected with the insulative portion at a point near the bottom of the insulative portion. With such an arrangement the third attachment section can substantially prevent the cooler from pivoting about a line defined by the first and second attachment sections. In some embodiments, attachment sections can be connected to the insulative portion on two or more sides of the insulative portion. This configuration allows for options in orientation of the cooler while being supported, and in some applications allows for the cooler to be supported on multiple sides.

The attachment elements are not limited to the mechanical structures shown in FIGS. 1A, 1B, 2A, and 2B, and described herein. For example, the attachment elements may comprise at least one of a clamping mechanism, a tether with a connector, a clip, a strap, a hook, and another suitable connecting apparatus that allows the cooler to attach to a structure. In some embodiments, multiple attachment element types are used. The material used to manufacture the cooler and the attachment element are not limited, and either or both may comprise at least one of plastic, nylon, vinyl, and a metal, for example aluminum. The attachment element may be integrally formed with the cooler, or may be separately formed. Separately formed attachment elements may be attached to the cooler for example through mechanical attachment mechanisms, such as rivets, screws, clamps, bolts, or equivalents thereof. The attachment element may additionally or alternatively be attached to the cooler with an adhesive. In some embodiments, the attachment element is connected to the cooler by mechanical forces generated by inserting the attachment element into an attachment feature in or on the cooler. Other attachment mechanisms may be used.

In some embodiments, the attachment element is configured to movably attach to the cooler. In some embodiments, the attachment element is configured to move between multiple positions. The positions may include a first position wherein the attachment element is configured to support the cooler and attach the cooler to a separate structure and a second position more convenient for use while the cooler is not attached to a cooler, for example when the cooler is being stored. The second position may configure the attachment element to be substantially flat against a surface of the cooler. In some embodiments, the attachment element pivots, folds or slides to the second position, and in the second position the attachment element is at least substantially flush with a surface of the cooler. In some embodiments (not shown) the attachment element is movable to recess into a wall of the cooler. In some embodiments, the attachment element is removably attached to the cooler, such that the user may conveniently attach and remove the attachment element to the cooler when desired.

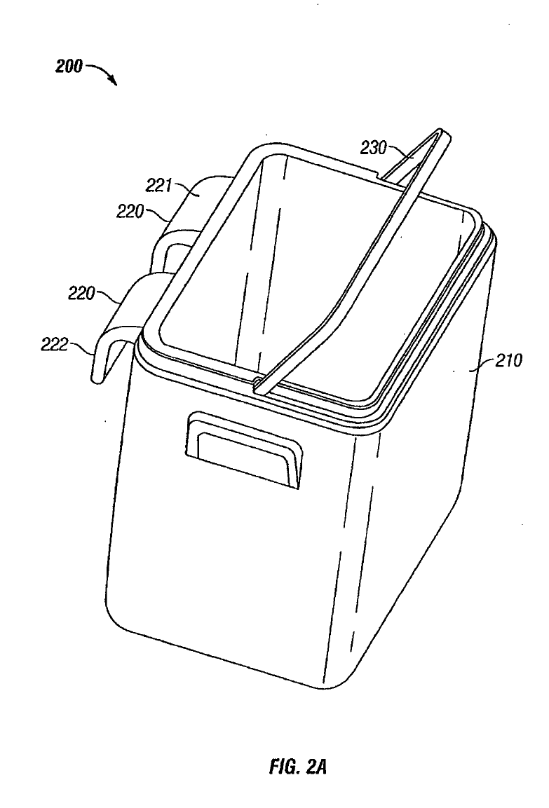

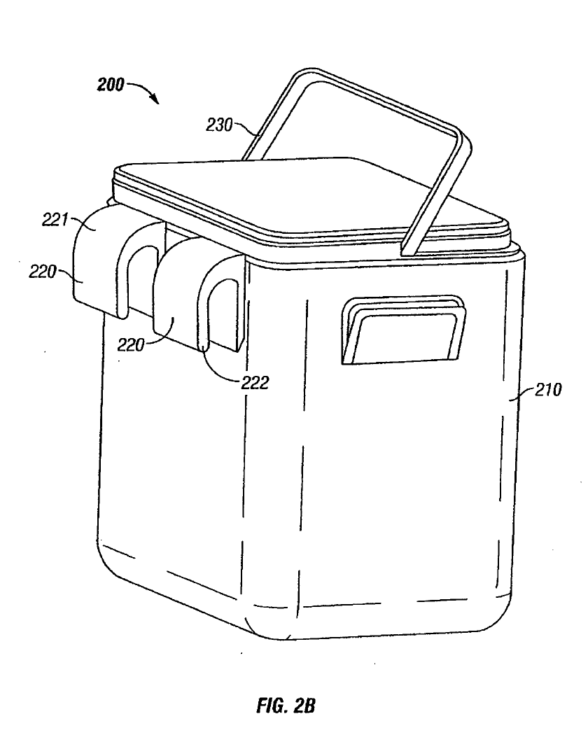

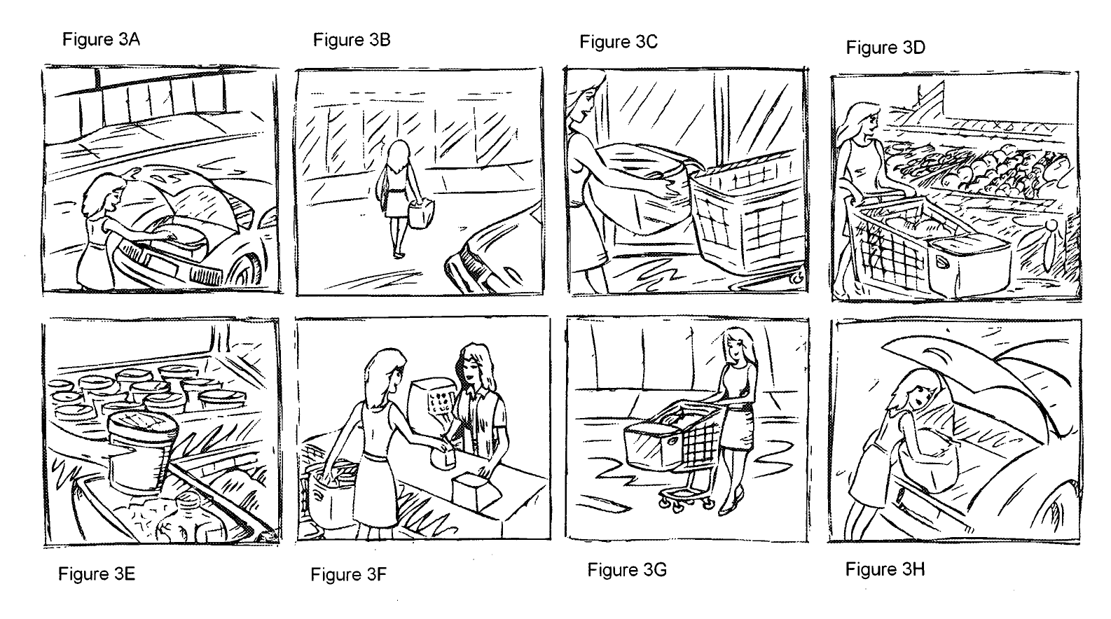

FIGS. 3A-3H illustrate how some embodiments can be used by a consumer. In FIG. 3A, the consumer removes the cooler from her car. In FIG. 3B, she carries the cooler to the store. In FIG. 3C, she attaches the cooler to a shopping cart using the attachment element. In FIG. 3D, she searches for items to buy in the store while pushing the cart with the cooler attached to the cart. As illustrated here, the length of the cooler can be dimensioned to be about no longer than the width of a shopping cart so that the profile of the cart does not increase (which would make it more difficult to successfully navigate narrow store aisles). In FIG. 3E, the consumer places a cold item into the cooler. In FIG. 3F, she pays for the purchased items. In FIG. 3G, she pushes the cart with the cooler toward her car. In FIG. 3H, she places the cooler, with the cold items therein, into her car.

Using the cooler, shopping capacity can be increased by 30% or more, enabling the shopper to potentially purchase that much more product in the same shopping experience. A shopping cart basket may, for example, have between 9 and 10 thousand cubic inches of available space. If the cooler 16 in×14 in×14 in, which is 3136 cubic in of available cold retaining space, then the shopping space would be increased by between about 31.4% and about 34.8%. This number would increase or decrease depending on the actual size of the shopping cart and the size of the cart cooler. Assuming that 20% of a shopper's groceries are refrigerated, the cooler would eliminate the need for 20% of the grocery bags that would otherwise be used.

Shoppers having any refrigerated or frozen items insulated in the cooler would be more inclined and better able to stay longer in the store to purchase additional items that they otherwise might not have purchased. This would also allow the shopper to more thoroughly be exposed to the entire store. In the case of a Wal-Mart, for example, where the store offers both food and hard goods if a shopper happened to remember something that they needed from the hard goods portion of the store they might be inclined to go back since they could feel secure that their cold product is remaining cold. Offering for sale a cooler having an attachment element may allow the store to sell a cooler to a customer who may otherwise have no intent in buying another cooler, because the cooler offers something unique and different from the coolers that the customer already owns. In some embodiments, advertising is printed on the cooler.

Many times a customer will return, swap out or simply put down certain cold or would be cold items as they might feel they have been in their cart too long. Using an attachable cooler as described herein can help prevent spoilage and reduce the marketer's cost. Should a customer need to make any additional stops, like to the post office, dry cleaner, pick up the kids, or other errands they could do so feeling comfortable that their groceries are kept cold and/or warm, and safe. This could also save the consumer time and money because of not having to reroute themselves or backtrack being sure that groceries were last on the list of things to do.

About 20-30% fewer bags would be used by the consumer and purchased by the marketers. Food having been maintained at the proper temperature throughout their life will cause them to last longer than otherwise making for less waste. Assuming that a customer already owns a cooler and would not ordinarily be a potential customer for a new cooler the fact that this cooler does something unique that others don't do that same customer might buy this cooler when they otherwise would have no reason to purchase another one.

While the above detailed description has shown, described, and pointed out novel features as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others.

What is claimed is:

1. A cooler, comprising:
a cooler body having an inside and an outside, said body having a top and a bottom and one or more walls extending between the top and the bottom, wherein the walls are insulated; and
an attachment element affixed to the cooler body, the attachment element adapted to connect a wall of the cooler body to a separate structure.

2. The cooler of claim 1, wherein the walls and the bottom of the cooler body are rigid, and wherein the attachment element is rigid.

3. The cooler of claim 2, wherein the attachment element comprises at least a first hooked structure rigidly attached a wall of the cooler body at an attachment point and extending outward from the attachment point and then downward, thereby allowing attachment of the cooler to a structure by engaging the hook down over the structure.

4. The cooler of claim 3, further comprising a second hooked structure separated from the first hooked structure.

5. The cooler of claim 1, wherein the walls of the cooler comprise foldable portions such that the cooler is substantially collapsible.

6. The cooler of claim 1, wherein at least one portion of the cooler is flexible.

7. The cooler of claim 1, wherein the attachment element is movably connected to the cooler.

8. A system for carrying foods, comprising:
a shopping cart having wheels, a basket mounted above the wheels, a handle, and a front end opposite the handle; and
a cooler removably attached to the front of the shopping cart.

9. The system of claim 8, wherein the cooler is attached to the shopping cart by one or more hooks extending over a portion of the basket.

10. The system of claim 8, wherein the cooler is mounted substantially inside the basket.

11. The system of claim 8, wherein the cooler is substantially outside the basket.

12. The system of claim 8, wherein the cooler comprises a lid.

13. A method for handling an item, the item being cooler than or warmer than the ambient environment, the method comprising:
transporting a cooler to a store;
attaching the cooler to a shopping cart at the store;
placing the item into the cooler;
detaching the cooler from the shopping cart; and
transporting the cooler containing the item away from the store.

14. The method of claim 13, wherein the cooler is removably attached to a shopping cart with at least one hook that extends downwardly over a portion of the shopping cart.

15. The method of claim 14, wherein the cooler is mounted outside of a shopping cart basket.

16. A food holding system, comprising:
a cooler having an attachment element, wherein the cooler has a side wall and the attachment element extends outwardly from the side wall and then downward the cooler being configured to hold food in the cooler that is colder than or warmer than ambient temperature; and
an extending structure over which or through which the cooler is attached by the attachment element.

17. The system of claim 16, wherein the attachment element is movably attached to the cooler.

18. The system of claim 16, wherein the extending structure is a part of a fence.

19. The system of claim 16, wherein the extending structure is a part of a seat.

20. The system of claim 16, wherein the extending structure is a part of a shopping cart.
